(19) United States
(12) Patent Application Publication
(10) Pub. No.: US 2016/0123259 A1
(43) Pub. Date: May 5, 2016

(54) METHOD FOR THE OPERATION OF AN EXHAUST-GAS TREATMENT SYSTEM, DEVICE FOR CONTROLLING AN EXHAUST-GAS TREATMENT SYSTEM, EXHAUST-GAS TREATMENT SYSTEM, ENGINE CONTROL UNIT, AND INTERNAL COMBUSTION ENGINE HAVING AN EXHAUST-GAS TREATMENT SYSTEM

(71) Applicant: MTU FRIEDRICHSHAFEN GMBH, Friedrichshafen (DE)

(72) Inventors: Guido SCHÄFFNER, Horgenzell (DE); Tim SPÄDER, Langenargen (DE)

(21) Appl. No.: 14/896,996

(22) PCT Filed: Apr. 16, 2014
(86) PCT No.: PCT/EP2014/001023

§ 371 Date: Dec. 9, 2015

(30) Foreign Application Priority Data
Jun. 11, 2013 (DE) 10 2013 210 896.6

(51) Int. Cl. F02D 41/02; F02D 41/14

(52) U.S. Cl. CPC F02D 41/0235; F02D 41/1466

(57) ABSTRACT

A method for an exhaust-gas treatment system having a diesel particle filter, in particular for the operation of an internal combustion engine having an exhaust-gas treatment system, in particular an internal combustion engine including a motor. The method includes the steps of: operating the diesel particle filter, in particular with regular regeneration; and determining a present soot loading of the diesel particle filter. Provision is made for a comparison of the present soot loading with a predetermined soot loading reference value to be performed and, if the soot loading reference value is undershot, for the soot particle loading in the diesel particle filter to be increased in order to adhere to the demanded emission limit value for the number of soot particles.

The invention pertains to a method for the operation of an exhaust gas treatment system with a diesel particulate filter, to a device for controlling the exhaust gas treatment system, and to an exhaust gas treatment system. The invention also pertains to an engine control unit and to an internal combustion engine.

It is known from the prior art that diesel particulate filters can be used to remove soot particles from an exhaust gas. Diesel particulate filters can comprise a fine-pored structure—e.g., a ceramic structure or, as described in US 2007-151,231 A, a fine-pored woven steel structure—on the walls of which the soot particles are deposited. To meet future exhaust gas standards, it is necessary to reduce the number of soot particles in the exhaust gas below certain limit values. It is known that diesel particulate filters can be regenerated; this ensures that the diesel particulate filter (DPF) does not become clogged and the engine does not become damaged and/or does not stall out. A distinction is made between passive regeneration and active regeneration; in the latter case, the soot particles are burned off at predetermined time intervals and/or after a predefinable trigger signal. In an exhaust gas treatment system with a passively regenerating diesel particulate filter, advantage is taken of the so-called CRT (Continuous Regeneration Trap) effect, and the diesel particulate filter is thus regenerated continuously, i.e., in particular without a fixed, predefined trigger signal; in addition, a suitable thermomanagement measure can be initiated, which, for example, involves a change in the engine operating mode such that the exhaust gas temperature is increased to support the burnoff of the soot particles in the exhaust gas. It would also be desirable to improve the filtering efficiency.

This is the starting point of the invention, the goal of which is to propose a method and a device by means of which the number of soot particles emitted in the exhaust gas can be reduced and in particular a diesel particulate can be operated with improved filtering efficiency also. At the same time, it should be possible to use existing diesel particulate filter technologies.

The goal with respect to the method is achieved by the invention in the form of a method for operating an internal combustion engine with an engine and an exhaust gas treatment system with a diesel particulate filter, which method comprises the following steps:
operating the diesel particulate filter, in particular with regular regeneration;
determining a current soot load of the diesel particulate filter.

According to the invention, it is provided that the current soot load is compared with a predetermined soot load reference value, and if the current load is below the soot load reference value, the soot particle load in the diesel particulate filter is increased.

In a general sense, “soot load” is understood to be any load parameter which can quantify the load. This can be, for example, the quantity of soot, e.g., its weight or volume, etc., or the number of particles.

The goal with respect to the device is achieved by a device according to claim 6 and by an exhaust gas treatment system according to claim 7. The invention also leads to an engine control unit according to claim 9 and to an internal combustion engine according to claim 10. The invention proceeds from the idea that it should be possible to operate a DPF in an optimized range especially for the purpose of achieving filtering efficiency. To this end, the invention has recognized that an optimized range is not usually present immediately after the DPF has been regenerated. It has been found that it is still possible to improve the filtering efficiency of a DPF immediately after a regeneration in particular. In principle, it is desirable to increase the filtering efficiency, that is, to improve the response rate of a DPF by bringing it as quickly as possible into an optimized operating range. It has been found that, in principle, it is possible to operate a DPF in an optimized soot load range.

The invention is based on the realization that increasing the number of soot particles in the diesel particulate filter increases the filtering efficiency of the diesel particulate filter. It was surprising to discover that the soot particle emission downstream from the diesel particulate filter can be reduced precisely by increasing the soot particle load of the diesel particulate filter (DPF).

Within the scope of a preferred elaboration, it has been found in particular that the filtering efficiency of a DPF with only a small load is worse than that of a more highly loaded DPF, and in particular it is worse than that of a DPF with an optimal load. According to the basic idea of the invention, the soot load can be adjusted in such a way that better filtering efficiency is achieved, and the number of particles is reduced more efficiently.

Accordingly, the concept of the invention provides for an optimized minimum load of a DPF in that, according to the invention, when the soot particle load in the diesel particulate filter falls below a reference value, the soot load is increased, in particular by an operating measure on the internal combustion engine specifically directed toward this goal. In effect, this leads to a comparatively rapid increase in the load of a DPF up to or beyond an optimized minimum load; it therefore allows the system to operate in the desired DPF soot load operating range.

Advantageous elaborations of the invention can be derived from the subclaims, which describe the details of advantageous ways in which the above-explained concept can be realized within the scope of the stated goal and which also adduce additional advantages.

It in also preferable in particular to specify an optimized maximum load for the DPF. This is advantageous because, when the reference value is exceeded, the soot particle load in the diesel particulate filter can be decreased, in particular by an operating measure of the internal combustion engine specifically intended for this purpose, especially by an operating measure such as a regeneration of the DPF, e.g., by means of a thermomanagement measure or the like.

It is preferable to operate the DPF within an optimized soot load operating range, i.e., preferably above the optimized minimum load of the DPF and below the optimized maximum load of the DPF.

There are in principle several alternative ways of achieving an optimized, in particular a minimum, soot load. It has been found to be especially advantageous to provide a DPF control device which can influence at least one engine characteristic, preferably by way of an engine control unit. Thus a device for controlling the DPF can act on an engine control unit in such a way that that, when the soot particle load in the diesel particulate filter falls below a reference value, the soot load is increased by increasing the soot emission and/or the exhaust gas temperature and/or the NOₓ emission in the exhaust gas upstream from the DPF.

In an elaboration of the method, the increase in the soot particle load in the diesel particulate filter is brought about by an emission-trimming process within the scope of the exhaust-gas conditioning carried out upstream from the diesel particulate filter, in particular by an exhaust-gas conditioning in a diesel oxidation catalyst, which is installed upstream from the diesel particulate filter. It is advantageous for this emission trimming to be realized by lowering the emission of NO₂ from the diesel oxidation catalyst, which results in a decrease in the amount of soot burned off by NO₂ in the diesel particulate filter.

In an especially advantageous elaboration, the soot particle load in the diesel particulate filter is increased by the initiation of an emission-trimming process in the engine. In an elaboration of the method, a nominal value of at least one engine characteristic selected from the group: soot emission, exhaust gas temperature, NOₓ emission, hydrocarbon emission, CO emission, and particle emission, is determined first as part of the emission-trimming process.

On the basis of this nominal value, at least one engine-specific controlled variable is then determined, and the engine is adjusted to this controlled variable, wherein the controlled variable is selected from the group: rail pressure, exhaust gas return (EGR) rate, charging pressure, lambda, intake-air throttling, and BOI (begin of injection). In addition to the controlled variables cited, it can also be advantageous to use other engine controlled variables.

In a preferred elaboration of the emission-trimming process, the engine characteristic is the soot emission, the exhaust gas temperature, or the NOₓ emission. An increase in the soot emission of the engine leads to an increase in the soot particles which arrive in the diesel particulate filter from the engine and which can be deposited there. If the exhaust gas temperature or the NOₓ emission is decreased, the amount of soot which is burned off from the diesel particulate filter is decreased, and thus the soot particle load in the diesel particulate filter is greater than that present during operation at a higher exhaust gas temperature or higher NOₓ emission.

In a preferred elaboration, compliance with the required NOₓ emission limits can also be ensured by an SCR (selective catalytic reduction) system installed downstream from the engine.

The load is advantageously determined by means of an evaluation of the differential pressure across the diesel particulate filter, by means of a load model, or with the help of a soot load sensor or soot sensor. For the evaluation of the differential pressure, it is advantageous in particular to use a corrected differential pressure, which takes into account the ash load component of the diesel particulate filter.

The invention also leads to a device for controlling an exhaust gas treatment system, especially with a regenerated diesel particulate filter, wherein the device is configured to implement a method according to claim 1 or claim 2, especially according to claim 2.

The invention also leads to an exhaust gas treatment system comprising a diesel particulate filter, especially a passively regenerating diesel particulate filter, wherein the exhaust gas treatment system comprises a control device according to the invention.

In an advantageous elaboration, the exhaust gas treatment system comprises not only the diesel particulate filter but also a diesel oxidation catalyst.

By means of the engine control unit, the engine exhaust gas can be adjusted in such a way that the amount of NO₂ emitted by the diesel oxidation catalyst is decreased; this can be done by changing the exhaust gas temperature, for example, or by changing the NO emission of the engine.

The invention also leads to an engine control unit which is configured to implement a method according to the invention, especially according to claim 3 or claim 4.

The invention also leads to an internal combustion engine with an engine and an exhaust gas treatment system with diesel particulate filter, especially a regenerating diesel particulate filter, wherein the internal combustion engine has an engine control unit of the previously mentioned type.

Exemplary embodiments of the invention are described in the following on the basis of the drawings. These are not necessarily intended to represent the embodiments to scale; instead, the drawings, where suitable for the purpose of explanation, are in schematic and/or slightly distorted form. With respect to amplifications to the teachings directly derivable from the drawings, reference is made to the relevant prior art. It is to be kept in mind here that many modifications and changes pertaining to the form and details of an embodiment can be undertaken without departing from the general idea of the invention. The features of the invention disclosed in the description, in the drawings, and in the claims can be essential to the elaboration of the invention both individually and in any desired combination. In addition, all combinations of at least two of the features disclosed in the description, in the drawings, and/or in the claims also fall within the scope of the invention. The general idea of the invention is not limited to the exact form or details of the preferred embodiments illustrated and described in the following, nor is it limited to an object which would be limited in comparison to the object claimed in the claims. When ranges of values are indicated, values lying within the cited limits are also intended to be disclosed as limit values and can be used and claimed as desired. For the sake of simplicity, the same reference symbols are used in the following for the same or similar parts or for parts which have the same or a similar function.

Additional advantages, features, and details of the invention can be derived from the following description of the preferred embodiments and from the drawings:

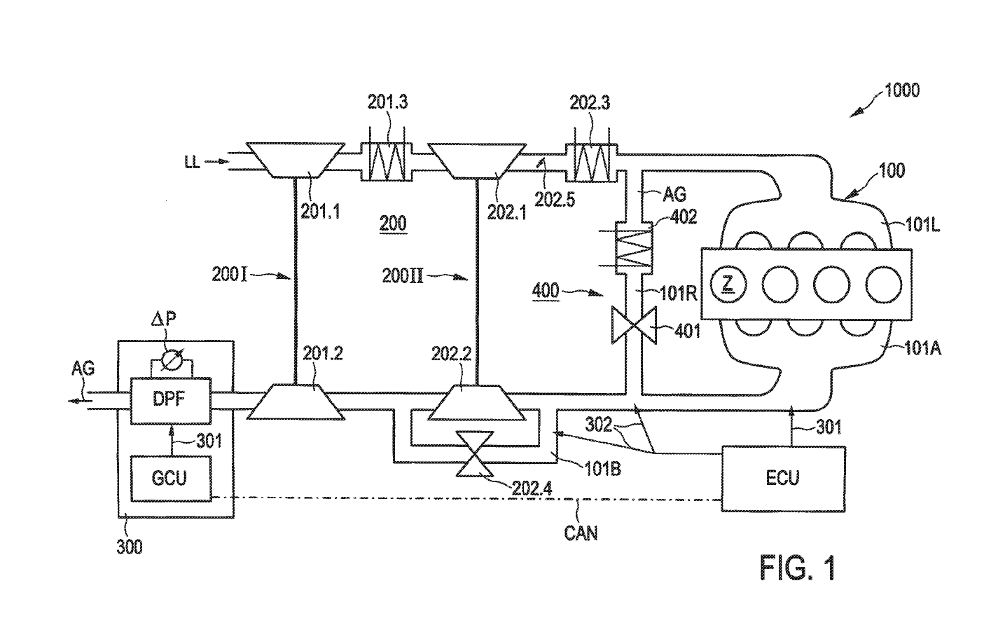

FIG. 1 shows a schematic diagram of a preferred embodiment of an internal combustion engine with an engine, a charger, and a system for exhaust gas treatment with a diesel particulate filter and a device for passive regeneration of the diesel particulate filter;

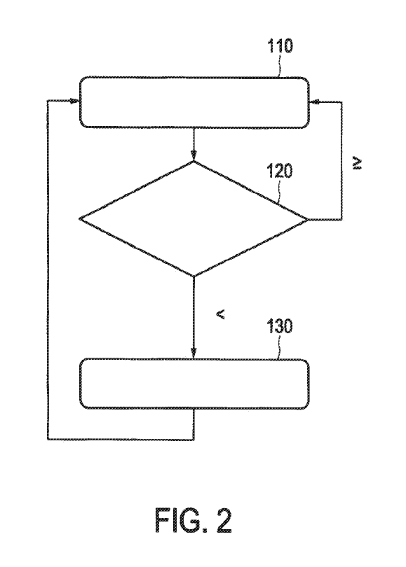

FIG. 2 is a flow chart illustrating the course of the method of exhaust gas treatment with a diesel particulate filter according to a preferred embodiment, wherein a comparison of the current soot load with a predetermined soot load reference value is carried out, and wherein, if the soot load is below the reference value, the soot particle load in the diesel particulate filter is increased;

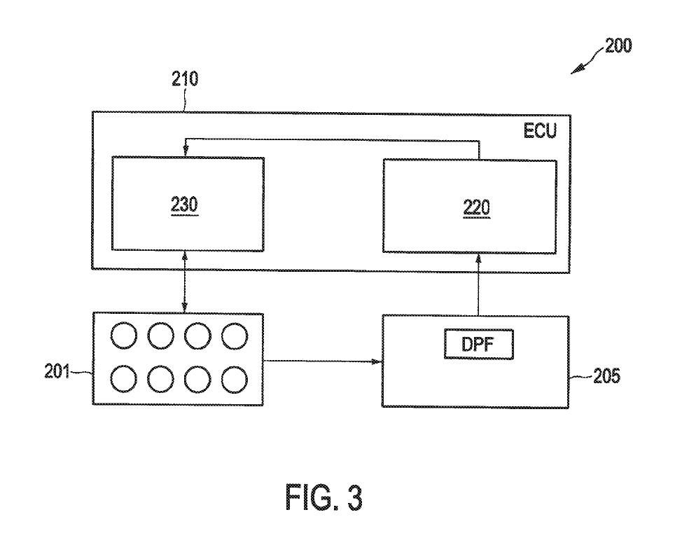

FIG. 3 is a diagram which illustrates the way in which a preferred embodiment of an internal combustion engine functions; and

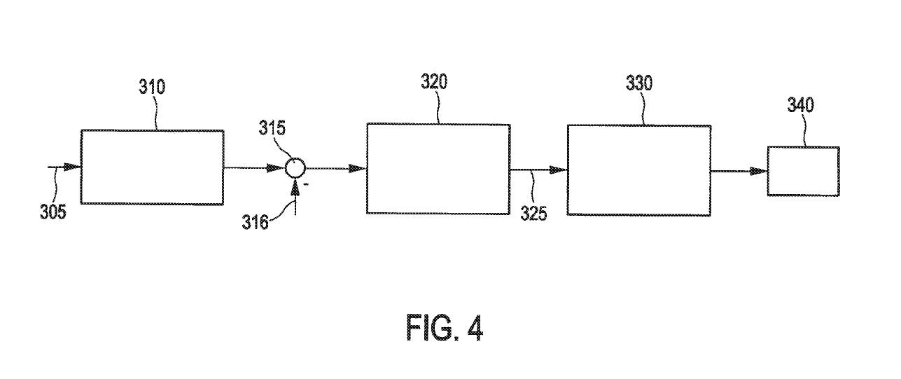

FIG. 4 shows a detailed schematic diagram of an embodiment of the course of the method of exhaust gas treatment with a diesel particulate filter

FIG. 1 shows an internal combustion engine 1000 with an engine 100, a charger 200, and a symbolically indicated exhaust gas treatment system 300 comprising a diesel particulate filter DPF, which can be subjected to thermomanagement measures by means of a control device GCU for the passive regeneration of the diesel particulate filter DPF. In the present case, the control device GCU of the exhaust gas treatment is accommodated as a module in a system comprising the exhaust gas treatment system, the diesel particulate filter, and the control device GCU. In the present case, the control device for controlling the passive regeneration of the diesel particulate filter—symbolized by the arrow 301—is functionally connected to a central control unit ECU of the internal combustion engine 1000 by a data and control bus CAN. The central control unit ECU, furthermore, as symbolically indicated by the arrows 301, 302, is configured to control the engine 100 and the charger. In the present case, the engine 100 is in the form of a diesel engine, the cylinders Z in the engine block being illustrated symbolically only by way of example; the cylinders are supplied with fuel by a common rail system with appropriate injection (not shown).

The charger 200 is connected to the engine block to supply charging air LL and to carry away exhaust gas AG by way of appropriate intake and exhaust manifolds, i.e., manifold 101L in the charging air line and manifold 101A in the exhaust gas line. The charger 200 is formed in the present case by a first charging stage 2001 and a second charging stage 20011, providing an appropriate arrangement of turbochargers, comprising compressors 201.1, 202.1 in the charging air LL line and turbines 201.2, 202.2 in the exhaust gas AG line. Downstream from each of the compressors 201.1, 202.1 is a charging air cooler 201.3, 202.3. The various charging stages, compressors, turbines, and coolers can also be described as low-pressure or high-pressure compressors, turbines, and coolers. The internal combustion engine 1000 and the charging system 200 shown here are described only as one example of an internal combustion engine with an exhaust gas treatment system 300 and are provided only to help explain that system.

The concept of the invention also comprises exhaust gas treatment systems for engines 100 without charging or only with a single-stage charger. In the present case, the charger is in fact set up as a two-stage charger for a large diesel engine; the high-pressure stage (second charging stage 20011) can be shut off by means of a waste gate 202.4 in an exhaust gas bypass line 101B. To control the charging, a throttle valve 202.5 is arranged in the charging air line 101L of the internal combustion engine 1000; this valve can be actuated in cooperation with the waste gate 202.4 to control the charging stages 20011, 2001 as needed, depending the load state of the engine 100.

In the present case, the internal combustion engine 1000 is also provided with an exhaust gas return system 400, wherein, in the exhaust gas return line 101R, an exhaust gas return valve 401 and an exhaust gas cooler 402 are arranged to treat the returned exhaust gas AG. The charger 200 and the exhaust gas return system 400 are operated as needed by actuation of the exhaust gas return valve 401 and the waste gate 202.4, as symbolized by the arrows 302.

In the following, the various steps of the method for treating exhaust gas by means of a diesel particulate filter and a device for controlling the exhaust gas treatment system 300 are illustrated and described on the basis of a preferred embodiment. A value of the current soot load is compared with a predetermined soot load reference value, and if the soot particle load in the diesel particulate filter is below the reference value, the soot load is increased. For the details, see the description of FIGS. 2, 3, and 4.

FIG. 2 is a flow chart illustrating the concept of the invention according to which, in this embodiment, the soot load of a diesel particulate filter is calculated in step 110 first. The calculated value is then compared in step 120 with a NOMINAL value for the soot load. If the calculated ACTUAL value is above the NOMINAL value or is equal to the NOMINAL value, the soot load of the diesel particulate filter is determined again. If, however, the calculated ACTUAL value of the soot load is below the specified NOMINAL value, an emission-trimming process is initiated in step 130, which leads to an increase in the soot particle load in the diesel particulate filter. At the end of the emission-trimming process, the soot load of the diesel particulate filter is determined again The increase in the soot particle load in the diesel particulate filter resulting from the emission-trimming process 130 leads to an increase in the filtering efficiency of the diesel particulate filter and thus to a decrease in the soot particle emission downstream from the diesel particulate filter. According to the invention, various embodiments of the emission-trimming process can be considered. As an alternative, this can be carried out within the scope of an exhaust-gas conditioning upstream from the diesel particulate filter, in which, for example, the emission of NO₂ is decreased, so that less NO₂ arrives in the diesel particulate filter and thus less soot is burned off from the diesel particulate filter. In another preferred embodiment of the method according to the invention, the emission-trimming process takes place within the scope of the engine control function, wherein a NOMINAL value of at least one engine characteristic is determined and the engine is adjusted to at least one engine-specific controlled variable, as a result of which the NOMINAL value is reached. Suitable controlled variables for adjusting the engine are, for example, the rail pressure, the EGR rate, the charging pressure, lambda, the intake-air throttling, or the BOI.

FIG. 3 shows schematically an embodiment of an internal combustion engine 200 according to the concept of the invention in terms of its function; for example, an internal combustion engine 1000 of FIG. 1 could be regulated in this way. The internal combustion engine 200 comprises an engine 201, and an exhaust gas treatment system 205 with a diesel particulate filter DPF, and an engine control unit 210 (ECU). The engine control unit 210 comprises a soot load calculator 220 and an engine controller 230. The soot load calculator 220 of the engine control unit 210 determines the soot load of the diesel particulate filter DPF by means of a load model or by means of the evaluation of the differential pressure measured across the diesel particulate filter DPF. This ACTUAL value for the load of the diesel particulate filter DPF is compared with a stored NOMINAL value for the soot load.

If the ACTUAL value is below the NOMINAL value, the engine control unit 210 starts an emission-trimming process. First, a NOMINAL value of at least one engine characteristic selected from the group: soot emission, exhaust gas temperature, NOₓ emission, hydrocarbon emission, CO emission, and particle emission, is determined. This NOMINAL value is sent to the engine controller, which determines an engine-specific controlled variable adapted to achieving the NOMINAL value and then adjusts the engine 201 to this controlled variable. Suitable controlled variables are, for example, the rail pressure, the EGR rate, the charging pressure, the intake-air throttling, lambda, or the BOI.

If, as a result of the adjustment of the engine 201, the exhaust gas temperature or the NO₂ emission, for example, is the characteristic which has been decreased, and the burnoff of soot in the diesel particulate filter is also decreased. Because soot particles from the exhaust gas continue to be deposited in the diesel particulate filter DPF, the soot particle load in the diesel particulate filter therefore increases. The increased soot particle load in the diesel particulate filter DPF leads in turn to an improvement in the filtering efficiency of the diesel particulate filter and to a decrease in the emission of soot particles downstream from the diesel particulate filter. Thus, by means of the invention, it is possible to meet exhaust gas standards even stricter than those currently being met.

FIG. 4 shows a schematic diagram of a method according to the invention. In step 305 of the method according to the invention, differential pressure values across the diesel particulate filter are recorded and, in the following step 310, they are used to determine the load of the diesel particulate filter. The ACTUAL value of the load determined in step 310 is compared in step 315 with a NOMINAL soot load value provided in step 316. If the ACTUAL value of the soot load is lower than the NOMINAL value of the soot load, an emission trimming process is then started in step 320, during which, first, a NOMINAL value of an engine characteristic is determined, which leads to an increase in the soot particle load in the diesel particulate filter. The acquired NOMINAL value of the engine characteristic is transmitted in step 325 to an engine controller, and in step 320 engine-specific controlled variables are determined, to which the engine can be adjusted to reach the NOMINAL value of the engine characteristic. The engine is then adjusted to the defined controlled variables in step 340.

1-10. (canceled)

11. A method for exhaust gas treatment with a diesel particulate filter, comprising the steps of:
operating the diesel particulate filter with regular regeneration;
determining an actual soot load of the diesel particulate filter;
comparing the actual soot load with a predetermined soot load reference value; and
increasing a soot particle load in the diesel particulate lifter if the actual soot load is below the reference value.

12. The method for an exhaust gas treatment according to claim 11, further comprising exhaust-gas conditioning, and initiating an emission-trimming process as part of the exhaust-gas conditioning to increase the soot particle load in the diesel particulate filter.

13. The method for an exhaust gas treatment according to claim 11, wherein the steps of increasing the soot particle load of the diesel particulate filter includes initiating an emission-trimming process for a motor of an internal combustion engine during operation of the internal combustion engine.

14. The method for exhaust gas treatment according to claim 13, wherein the emission-trimming process comprises the steps of;
determining a NOMINAL value of at least one motor characteristic, selected from the group consisting of soot emission, exhaust gas temperature, NOx emission, hydrocarbon emission, CO emission, and particle emission;
determining at least one engine-specific controlled variable that produces the nominal value; and
adjusting the motor to reach the at least one controlled variable from the group consisting of: rail pressure, EGR rate, charging pressure, lambda, intake-air throttling, and BOI.

15. The method for exhaust gas treatment according to claim 11, wherein the load is determined by evaluation of differential pressure or by a load model or using a soot load sensor or soot sensor.

16. A device for controlling an exhaust gas treatment system with a regenerating diesel particulate filter, wherein the device is configured to implement the method according to claim 11.

17. An exhaust gas treatment system comprising a diesel particulate filter, wherein the exhaust gas treatment system comprises a control device according to claim 16.

18. The exhaust gas treatment system according to claim further comprising a diesel oxidation catalyst.

19. An engine control unit, which is configured to implement the method according to claim 11.

20. An internal combustion engine, comprising: a motor; an exhaust gas treatment system with a diesel particulate filter; and a control device according to claim 16.

21. An internal combustion engine, comprising: a motor; an exhaust gas treatment system with a diesel particulate filter; and an engine control unit according to claim 19.
